(19) United States
(12) Patent Application Publication
(10) Pub. No.: US 2011/0077032 A1
(43) Pub. Date: Mar. 31, 2011

(54) Restriction Method and Apparatus for Texting Based on Speed

(76) Inventors: Harry Benjamin Correale, Cooper City, FL (US); Clifford Kraft, Naperville, IL (US)

(21) Appl. No.: 12/568,755

(22) Filed: Sep. 29, 2009

(51) Int. Cl. G05B 19/02; H04W 4/14

(52) U.S. Cl. 455/466

(57) ABSTRACT

A method and apparatus for preventing texting on cellular telephones while driving. A cellular telephone moving faster than a predetermined speed (for example 15 MPH) automatically locks out the texting function. Dialing of full telephone numbers under these conditions can also be locked out. If the phone becomes stationary for a predetermined period (say 3 minutes), the lockout can be removed. A passenger can enter an override code to prevent the lockout. In some embodiments the override code can only be entered when the phone is moving faster than the predetermined speed and/or when several buttons are depressed simultaneously requiring operation with two hands.

### BACKGROUND

1. Field of the Invention

The present invention relates to the general field of safety and more particularly to a method and apparatus for preventing texting when a particular cellular telephone is in motion.

2. Description of the Prior Art

Texting is the typing out of text messages on a cellular telephone or computer (called SMS). The resulting message can be immediately received by another cellular telephone or computer. The problem is that there have been numerous traffic accidents, as well as at least one train accident where the driver was attempting to text while operating the vehicle. This is a particular example of a larger set of problems classified as “distracted driving”. Some states have passed laws making it illegal to text while driving a motor vehicle; however, simply passing a law does not prevent people, especially teen-agers, from still attempting this. A recent Virginia Tech Transportation Institute study found that manual text messaging elevated the risk of a crash or near crash to more than 23 times higher than “non-distracted” driving. Next to texting, trying to enter a full telephone number (non-speed dial) into the telephone while driving is also very dangerous.

Clearly what is needed is a method and apparatus that can be incorporated into a cellular telephone that simply prevents texting and/or entering a full telephone number while the cellphone is moving above a nominal speed—say around 15 MPH.

### SUMMARY OF THE INVENTION

The present invention relates to a method and apparatus that can be incorporated into a cellular telephone by phone manufacturers that prevents texting while moving above a certain predetermined speed (for example around 15 MPH). Optionally, this feature can also prevent entry of a full telephone number while so moving. All cellular telephones currently on the market contain a GPS receiver. Also, some specialized cellular telephones (such as telephones manufactured by Apple Corp.) contain accelerometers that are used to determine the orientation of the phone unit. Both the GPS, and the accelerometers can be used to determine speed. More future cellular telephones may also be equipped with accelerometers. A hybrid using both GPS information and accelerometer information is a preferred embodiment.

The signal from a GPS receiver either contains a speed (velocity) output that can be used directly by the telephone's processor to determine speed, or the GPS receiver outputs location signals that can be differentiated numerically to determine speed. Accelerometers on the other hand measure linear acceleration along various axes that can be integrated to produce speed values. A known problem with GPS is that in some locations, GPS signals are very hard to receive (and lock into). Such locations include tunnels, downtown urban locations with high buildings, and the like. This is because most GPS receivers, including those used in cellular telephones, must have line-of-sight communications between the telephone and at least two (preferably three) satellites in the sky. This is simply not possible in some locations. Telephone emergency location systems sometimes use what is called “assisted GPS” where the GPS receiver is helped by a base station to lock location or they use other methods of location such as base station triangulation.

An accelerometer works anywhere; however, straight integrated accelerometer systems (called inertial navigation systems) tend to drift very quickly after they have been set (they are very susceptible to noise such as jiggling, dropping the phone, banging it, etc.). Professional inertial navigation systems such as those used in commercial aircraft generally use gyros for stability and rotation as well as accelerometers and are many times backed up with GPS. A hybrid system combining the features of both GPS and an accelerometer leads to a system that can determine the speed at which a telephone is moving to a high degree of accuracy and in locations where GPS reception may be marginal.

The present invention can this run in any of three modes: 1) straight GPS, 2) Straight inertial using an accelerometer, and 3) combined GPS and inertial. Whichever mode is used, a speed determining circuit can decide what speed the telephone is traveling. When a particular speed is exceeded, the present invention can disable the keypad for texting, dialing or any keypad activity.

Of course, not everyone in a moving vehicle is the driver. There are passengers in both motor vehicles and trains and busses. These passengers may want to text or make calls and do not want their keypads disabled simply because they are moving. The present invention allows a passenger to enter a special code that temporarily disables the texting lockout. One embodiment of this special code is a code that requires two hands on the telephone simultaneously to enter. While it is possible that a driver could perform this feat and disable the texting restriction, it requires a totally deliberate and intentional act—an act that could be made criminal. In one embodiment, the special override code can only be entered when the vehicle is moving at least as fast as some predetermined speed (say 15 MPH). This would prevent the driver from illegally entering the override before starting to drive. Finally, the present invention can generally allow certain 3-digit codes such as 911 or *666, *999 which are used as emergency codes to always be entered.

After the telephone has locked out texting or other keypad activity, it can re-enable the keypad when the vehicle has stopped for a given period of time such as two minutes. The keypad should not normally be immediately re-enabled simply because the vehicle has stopped since it would re-enable at each stop light. This could encourage drivers to text while waiting for stop lights. A stop for around at least three minutes or more should be necessary to remove the lockout.

The present invention has the potential to save thousands of lives by preventing one of today's most dangerous situations—a driver texting or trying to full dial a call while trying to drive a car, bus or train.

### DESCRIPTION OF THE FIGURES

Attention is now called to certain illustrations that serve to aid in understanding various features of the present invention.

FIG. 1 shows a general block diagram of a cellular telephone with GPS and an accelerometer.

FIG. 2 shows a cellular telephone speed determiner circuit connecting the telephone processor, the GPS receiver, the accelerometer, telephone side and back buttons.

FIG. 3 shows a back view of a cellular telephone handset with side and back buttons requiring two-handed operation.

FIG. 4 shows a flowchart of a texting disable routine for a telephone processor.

Several drawings and illustrations have been presented to aid in understanding the present invention. The scope of the present invention is not limited to what is contained in the figures.

### DESCRIPTION OF THE INVENTION

The present invention is directed to a method and apparatus for partially disabling the keypad of a cellular telephone when it is moving above a predetermined speed to prevent texting and optionally entry of full telephone numbers while driving. Typically, the invention will allow entry of 3 or 4 digit emergency codes in a non-texting mode. The present invention can optionally allow an override code to be entered that prevents lock-out. In some embodiments, this lock-out can only be entered while moving and may require two-handed operation to enter it.

The present invention contains a speed determining circuit within the cellular telephone that allows the telephone's processor to decide if the phone is moving, and if so, at what speed. This speed determining circuit can be based entirely upon GPS, upon one or more accelerometers, or upon a hybrid of both. Any speed determining circuit (that is a circuit that provides information usable by a process to determine speed) is within the scope of the present invention.

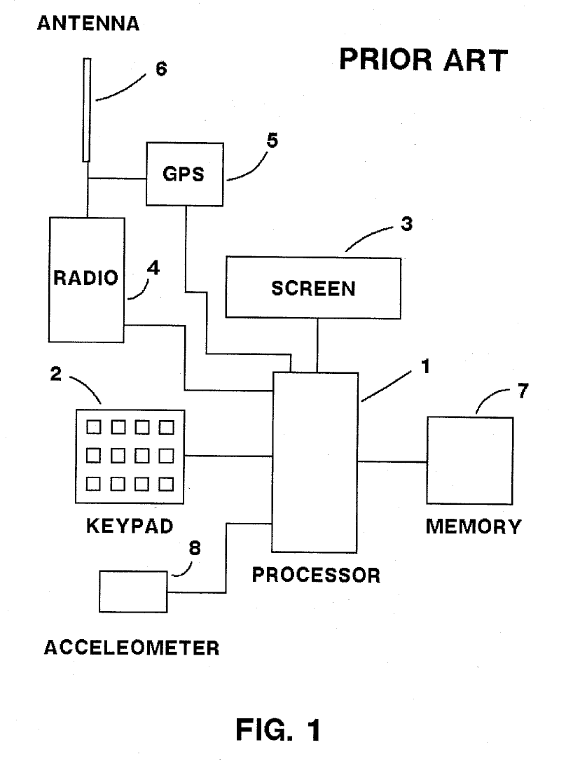

Turning to FIG. 1, a simplified block diagram of a prior art cellular telephone can be seen. The telephone contains at least one processor 1, a keypad 2, a screen 3, an radio section 4, a GPS receiver 5, and a radio/GPS antenna 6 and a memory 7. In some telephones, the radio/GPS antenna 6 takes the form of two separate antennas. In addition, many cellular telephones contain at least one accelerometer 8 that can feed acceleration values to the processor 1 to determine case orientation. In general, the processor 1 executes stored programs, including an operating system, from the memory 7. The memory 7 can include volatile and non-volatile parts (RAM and ROM). The non-volatile part (ROM) usually holds the executable code for various programs, while the volatile part (RAM) provides execution space, stack space and sometimes registers.

The processor 1, executing standard telephone executable code can determine when the user wishes to text and/or when the user has entered more than 3-4 digits in dialing a telephone number. On prior art telephones, the processor 1 simply lets this process proceed accepting the text or the telephone number and then taking the appropriate action on the radio channel by either sending the text in a texting channel (different with different telephone systems) or placing the call. In the present invention, a decision will be made as to whether these actions will be allowed. This decision is based on the speed the telephone is traveling.

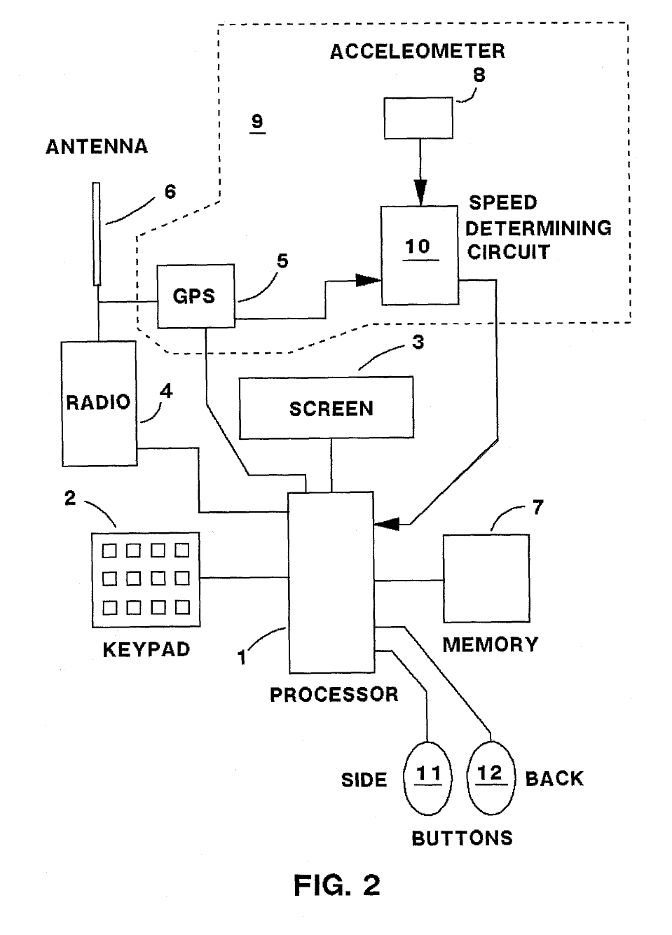

FIG. 2 shows an embodiment of the present invention including a speed acquisition circuit 9 that includes a GPS receiver 5, an accelerometer 8 and a speed computation chip or circuit 10 connected to the telephone processor 1. In various embodiments of the present invention, the speed acquisition circuit 9 may in some cases include only the GPS receiver 5, while in other cases it may include only the accelerometer 8. In all cases, the speed determining chip or circuit 10 is optional. When there is no speed determining chip or circuit, all speed determination can be performed directly from inputs by the telephone processor 1. From a telephone design point of view, it is desirable to perform the speed computation separately from the telephone main processor in order to not overload that main processor. In some embodiments of the present invention, the GPS receiver 5 will directly feed speed data to the telephone processor 1. The speed determining chip or circuit 10 can be a separate circuit containing a small separate processor, or it can be an ASIC specially designed speed chip containing an embedded processor. An ASIC is the preferred method. The speed determining chip or circuit 10 can perform integration from the accelerometer as is known in the art to determine speed. It can also differentiate GPS position if necessary to also determine speed. It can then use a weighted averages, mathematical estimation techniques or Kalman filtering known in the art, or artificial intelligence algorithms to provide the most accurate estimate of speed.

In the full configuration of FIG. 2, the speed determining chip or circuit 10 performs integration known in the art on acceleration data fed from the accelerometer 8. It also accepts either GPS speed data directly from the GPS receiver 5, or more likely, accepts GPS position signals or GPS pseudo ranges from the GPS receiver 5. Pseudo ranges are the most common form of output supplied by cellular telephone GPS receivers; however, longitude/latitude or other position data is becoming more common. Pseudo ranges are simply distances from the locked satellites. The speed determining chip or circuit 10 generally determines a rest state (to zero the inertial part of the computation) from the GPS receiver 5 or optionally, from being at rest (no accelerations at all) for a period of time (such as 5 minutes for example). Accelerations are integrated to maintain a moving linear speed estimate. Output from the GPS receiver can used to provide a separate speed estimate either by directly supplying a speed signal, by supplying locations, or by supplying pseudo ranges.

The speed acquisition circuit 9 supplies the telephone's actual speed to the telephone processor 1 on a regular basis (for example every second). The telephone processor 1 can then determine whether to lock out keypad functions or not. As stated, in some embodiments, there is no external speed determining circuit or chip, and a speed determination computation is run periodically within the telephone processor 1 using information directly from the GPS or accelerometer.

Any method that locks out texting or dialing based on the speed of the telephone is within the scope of the present invention. The simplest embodiment is for the processor to simply lock out texting and/or dialing if the telephone is moving at greater than a particular chosen speed such as 15 MPH. This simple technique may be annoying to passengers who will also be locked out. A different embodiment allows an override code to be entered from the keypad (or phoned in from another phone by a parent for example). The override may have a duration for a particular period such as 1-2 hours at which time the override would have to be re-entered. However, a simple override seems to invite a teenage driver to simply enter it. Thus, other embodiments of the invention only allow entering the override code when the telephone is moving and/or by using both hands.

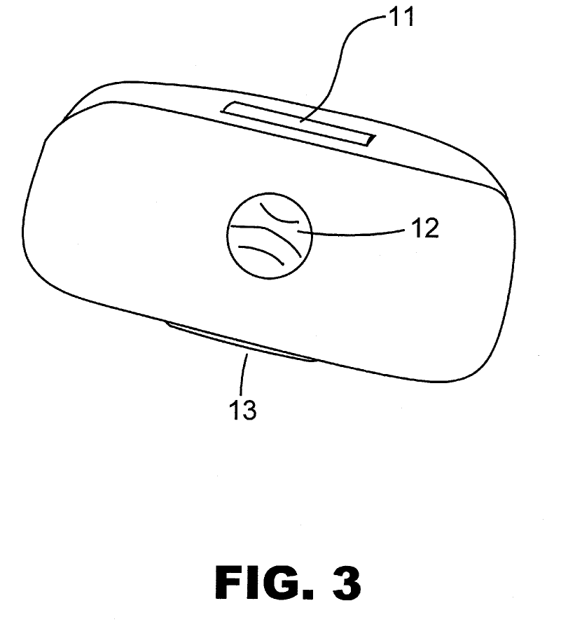

The most secure technique, requires the telephone to have special buttons that require one hand to activate, while requiring the other hand to enter the code. FIG. 2 shows these buttons schematically attached to the processor 1, while FIG. 3 shows a cellular telephone case with a side button 11 and a back button 12. To enter an override on this telephone, both the side 11 and back 12 button must be depressed simultaneously. The back button 12 can be concave to prevent the driver from simply pressing it on their leg or on a seat. An optional second side button 13 can also be used to assure that all three buttons cannot be depressed and the code entered with one hand. The code can be very simple (and hence easy to remember) such as 123456789; however, with the two buttons, it cannot generally be entered by one hand, and it cannot be entered at all unless the telephone is moving above the desired speed. This makes it very easy for a passenger to enter it but very difficult for a driver to enter it. If the phone has been motionless for over 3 minutes (or other desired value), it can unlock allowing full functioning of the keypad. If the phone begins to move faster than 15 MPH (or other desired value), the keypad locks out texting or full number dialing. A passenger can then easily enter the override code, while a driver cannot. This most secure technique prevents most drivers of motor vehicles, including bus drivers, from texting. As stated, the code may also be phoned in from another authorized telephone (from a parent for example).

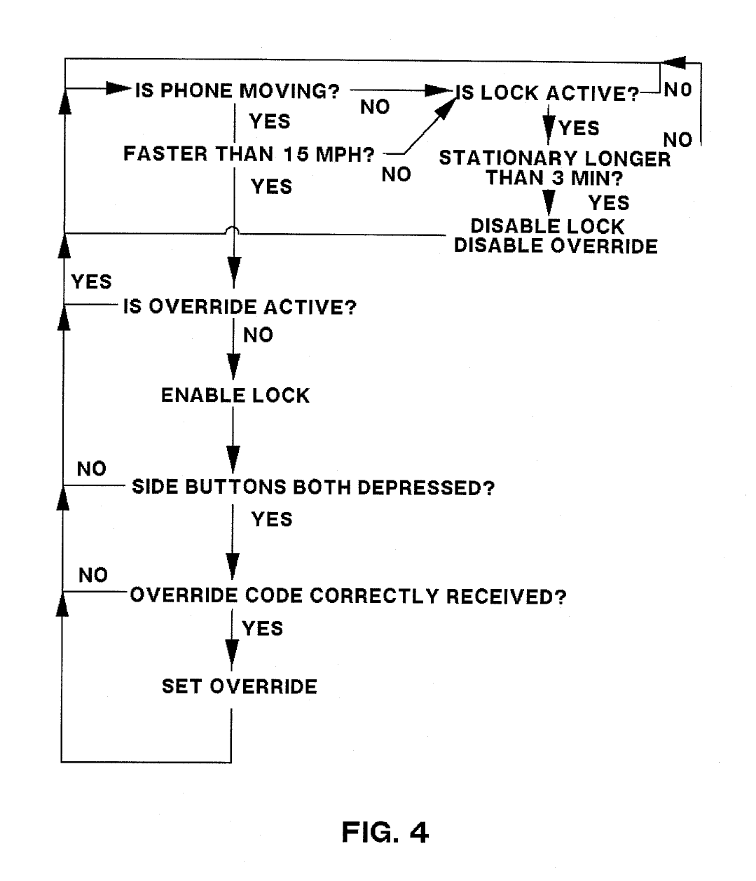

FIG. 4 shows a flowchart for the secure technique described above. If a lower security method is used, the appropriate boxes on the chart may be ignored. The routine shown in FIG. 4 generally runs as a loop on the telephone main processor 1. The first check is whether the phone is moving faster than the desired speed (in the example of FIG. 4, 15 MPH). If the phone is not moving, a check is made to see if a keypad lock is active. If so, and the phone has been not moving for 3 minutes, the keypad lock is removed allowing texting and full number dialing. Also, if an override was in place, it is removed. If the phone is moving faster than 15 MPH, a check is made to see if an override is active. If so, no action is taken. If not, a keypad lock is put in place. If the phone is moving, a check is made to see if the side and back buttons are being pressed simultaneously. If not, no action is taken. If they are being pressed simultaneously, a check is made to see if an override code has been entered. If not, no action is taken. If so, and the override code is correct, an override is put into place locking the keypad to texting and/or long dialing.

The present invention can save numerous lives by positively locking out texting and long number dialing while driving. The invention can partially distinguish between a driver and a passenger by allowing, in several embodiments, a passenger to enter an override code. Further requirements can be put into place to prevent a driver from entering this code: 1) the phone must be moving to enter the code, and 2) several buttons must be simultaneously depressed requiring the use of two hands.

Several descriptions and illustrations have been presented to aid in understanding the present invention. A person of skill in the art will realize that there are numerous changes and variations and/or combinations that can be made without departing from the spirit of the invention. Each of these changes, combinations or variations is within the scope of the present invention.

We claim:

1. A method that prevents texting on a cellular telephone while driving comprising locking out texting functions when said cellular telephone is moving at a speed of greater than a predetermined speed.

2. The method of claim 1 wherein said telephone also locks out dialing numbers longer than 4 digits when said cellular telephone is moving at a speed of greater than said predetermined speed.

3. The method of claim 1 wherein said predetermined speed is around 15 MPH.

4. The method of claim 1 wherein a passenger can enter an override code wherein said override code allows texting.

5. The method of claim 4 wherein said passenger can only enter said override code when said cellular telephone is moving at a speed of greater than said predetermined speed.

6. The method of claim 4 wherein said passenger can only enter said override code by simultaneously depressing at least two different buttons on said cellular telephone.

7. The method of claim 1 wherein said locking is removed when said cellular telephone has been stationary for a predetermined time.

8. The method of claim 7 wherein said predetermined time is around 3 minutes.

9. The method of claim 1 wherein said cellular telephone contains a speed determining circuit, said speed determining circuit receiving data from a GPS receiver.

10. The method of claim 1 wherein said cellular telephone contains a speed determining circuit, said speed determining circuit containing an accelerometer.

11. A method for preventing texting and full number dialing by a driver on a cellular telephone comprising:
determining whether said cellular telephone is moving faster than a predetermined speed;
determining whether an override code has been entered;
locking out texting and full number dialing if said cellular telephone is moving faster than said predetermined speed and no override code has been entered.

12. The method of claim 11 wherein said override code can only be entered when said cellular telephone is moving faster than said predetermined speed.

13. The method of claim 11 wherein said override code can only be entered when at least two different buttons on said cellular telephone are depressed simultaneously.

14. The method of claim 11 wherein said cellular telephone contains a speed determining circuit that includes an accelerometer and input from a GPS receiver.

15. A cellular telephone comprising:
a processor;
a speed determining circuit coupled to said processor;
wherein said processor locks out texting functions when said speed determining circuit reports that said cellular telephone is traveling faster than a predetermined speed.

16. The cellular telephone of claim 15 wherein said processor also locks out full number dialing when said speed determining circuit reports that said cellular telephone is traveling faster than said predetermined speed.

17. The cellular telephone of claim 15 wherein said processor is adapted to receive an override code, and when said processor receives said override code, said processor allows texting regardless of speed.

18. The cellular telephone of claim 15 wherein said speed determining circuit is in electrical communication with a GPS receiver.

19. The cellular telephone of claim 15 wherein said speed determining circuit contains an accelerometer.

20. The cellular telephone of claim 17 further comprising two separate buttons which must be simultaneously pressed for said processor to receive said override code.
